(19) United States
(12) Patent Application Publication
(10) Pub. No.: US 2026/0192781 A1
(43) Pub. Date: Jul. 9, 2026

(54) COMPRESSOR AND SENSOR CLEANING SYSTEM INCLUDING THE SAME

(71) Applicants: HYUNDAI MOTOR COMPANY, Seoul (KR); KIA CORPORATION, Seoul (KR)

(72) Inventors: Jong Geon Lee, Hwaseong-si (KR); Je Yeon Kim, Hwaseong-si (KR); Yeon Su Kim, Incheon (KR); Wan Cheol Lee, Incheon (KR)

(73) Assignees: HYUNDAI MOTOR COMPANY, Seoul (KR); KIA CORPORATION, Seoul (KR)

(21) Appl. No.: 19/310,566

(22) Filed: Aug. 26, 2025

(30) Foreign Application Priority Data
Jan. 7, 2025 (KR) 10-2025-0001938

(51) Int. Cl. B60S 1/56; B60S 1/54; F04B 39/00; F04B 49/12

(52) U.S. Cl. CPC B60S 1/56; B60S 1/54; F04B 39/0022; F04B 49/125

(57) ABSTRACT

A compressor may include a piston rod configured to be eccentrically coupled to a rotation shaft of a power device, and a piston body configured to be connected to the piston rod to perform a linear motion. The piston body includes a first piston head and a second piston head. The compression further includes: a first cylinder configured to intake or discharge fluid based on movement of the first piston head within the first cylinder; and a second cylinder configured to intake or discharge the fluid based on movement of the second piston head within the second cylinder.

### CROSS-REFERENCE TO RELATED APPLICATION

This application claims under 35 U.S.C. § 119(a) the benefit of Korean Patent Application No. 10-2025-0001938, filed on Jan. 7, 2025, the entire contents of which are incorporated herein by reference.

### FIELD

The present disclosure relates to a compressor.

### BACKGROUND

The statements in this section merely provide background information related to the present disclosure and may not constitute prior art.

A compressor may generate compressed fluid by taking in and compressing a fluid, such as air. The compressor is utilized across various industrial fields.

For example, the compressor may be used in vehicles. It is commonly applied in vehicle systems, such as an air conditioning systems and air suspension systems. Recently, compressors have also been used to clean environmental sensors configured to detect the surroundings of a vehicle.

### SUMMARY

Various embodiments are directed to providing a compressor with increased compression efficiency. In consideration of limited installation space in vehicles, the compressor is configured to be compact. In addition, the compressor provides high compression efficiency to effectively generate compressed fluid for cleaning environmental sensors.

The present disclosure provides a compact compressor with increased compression efficiency.

An embodiment of the present disclosure is directed to a sensor cleaning system that includes a compressor with increased compression efficiency.

The embodiments and objects of the present disclosure are not limited to those mentioned above, and other features and objects should be clearly understood by one having ordinary skill in the art to which the present disclosure pertains based on the description below.

The features of the present disclosure for achieving the object described above and performing the characteristic functions of the present disclosure described below are as follows.

In an embodiment of the present disclosure, a compressor may include a piston rod eccentrically coupled to a rotation shaft of a power device, and a piston body connected to the piston rod to linearly move. The piston body includes a first piston head and a second piston head. The compressor further includes: a first cylinder configured to intake or discharge fluid based on movement of the first piston head within the first cylinder; and a second cylinder configured to intake or discharge the fluid based on movement of the second piston head within the second cylinder.

In an embodiment of the present disclosure, a sensor cleaning system includes a compressor and a compression tank configured to store compressed fluid generated by the compressor. The compressor may include a piston rod eccentrically coupled to a rotation shaft of a power device; a piston body connected to the piston rod to linearly move and including a first piston head and a second piston head; a first cylinder configured to intake or discharge fluid based on movement of the first piston head within the first cylinder; and a second cylinder configured to intake or discharge the fluid based on movement of the second piston head within the second cylinder.

In the present disclosure, the compressor with increased compression efficiency is provided.

In the present disclosure, the compact compressor with increased compression efficiency is provided.

In the present disclosure, the sensor cleaning system that includes a compressor with increased compression efficiency is provided.

The effects of the present disclosure are not limited to the effects described above, and other unstated effects will be clearly understood by those having ordinary skill in the art from the description below.

### BRIEF DESCRIPTION OF THE DRAWINGS

In order that the disclosure may be well understood, there will now be described various forms thereof, given by way of example, reference being made to the accompanying drawings, in which:

FIG. 1 is a schematic diagram illustrating a vehicle sensor cleaning system in an embodiment of the present disclosure;

FIG. 2 is a view schematically illustrating a vehicle;

FIG. 3 is a cross-sectional view of a cylinder in a piston-type compressor;

FIG. 4 is a view illustrating an operation of a piston-type compressor;

FIG. 5A is an exploded view of a compressor according to an embodiment of the present disclosure;

FIG. 5B is a partial cutaway view of a cover plate of a compressor according to an embodiment of the present disclosure;

FIG. 6 is an exploded perspective view of a portion of a compressor according to an embodiment of the present disclosure;

FIG. 7 is an exploded perspective view of a piston body of a compressor according to an embodiment of the present disclosure;

FIG. 8 illustrates an operation process of a portion of a compressor according to an embodiment of the present disclosure;

FIG. 9A illustrates an operation process of a portion of a compressor according to an embodiment of the present disclosure;

FIG. 9B illustrates a state in which a first cylinder is in the compression process and a second cylinder is in the intake process in a compressor according to an embodiment of the present disclosure;

FIG. 9C illustrates a state in which a first cylinder is in the intake process and a second cylinder is in the compression process in a compressor according to an embodiment of the present disclosure;

FIG. 10 is a perspective view of a compressor according to an embodiment of the present disclosure;

FIG. 11 illustrates the flow of fluid in a compression mode and regeneration mode of a compressor according to an embodiment of the present disclosure.

The drawings described herein are for illustration purposes only and are not intended to limit the scope of the present disclosure in any way.

### DETAILED DESCRIPTION

Specific structural or functional descriptions described in embodiments of the present disclosure are exemplified only for the purpose of describing the embodiments according to the concept of the present disclosure, and the embodiments according to the concept of the present disclosure may be carried out in various forms. In addition, the present disclosure should not be interpreted as being limited to the embodiments disclosed in the present specification, and it should be understood that the present disclosure includes all modifications, equivalents, and alternatives included in the spirit and the technical scope of the present disclosure.

The terms such as “first” and/or “second” in the present disclosure may be used to describe various constituent elements, but these constituent elements should not be limited by these terms. These terms are used only for the purpose of distinguishing one constituent element from other constituent elements. For example, without departing from the scope according to the concept of the present disclosure, a first constituent element may be referred to as a second constituent element, and similarly, the second constituent element may also be referred to as the first constituent element.

When one constituent element is described as being “coupled” or “connected” to another constituent element, it should be understood that one constituent element can be coupled or connected directly to another constituent element, and an intervening constituent element can also be present between the constituent elements. Conversely, when one constituent element is described as being “coupled directly to” or “connected directly to” another constituent element, it should be understood that no intervening constituent element is present between the constituent elements. Other expressions, that is, “between” and “just between” or “adjacent to” and “directly adjacent to”, for describing a relationship between constituent elements, should be interpreted in a similar manner.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

Like reference numerals indicate like constituent elements throughout the present specification. The terms used in the present specification are for describing the exemplary embodiments, not for limiting the present disclosure. Unless particularly stated otherwise in the present specification, a singular form also includes a plural form. The terms “comprise” and/or “comprising” used in the specification are intended to specify the presence of the mentioned constituent elements, steps, operations, and/or elements, but do not exclude presence or addition of one or more other constituent elements, steps, operations, and/or elements.

Embodiments of the present disclosure are described hereinafter with reference to the accompanying drawings.

For driver assistance systems or autonomous driving, various environmental sensors are installed in vehicles to detect the surrounding environment. These environmental sensors are mounted on the exterior of the vehicle, so they may be easily contaminated by foreign substances, such as dust or precipitation. To maintain performance, environmental sensors need to be kept clean above a certain level. Accordingly, a sensor cleaning system is provided in the vehicle to clean the environmental sensors in case of contamination.

Such a sensor cleaning system may utilize a compressor. The sensor cleaning system is configured to spray compressed fluid, compressed by the compressor, onto the environmental sensors to clean the environmental sensors.

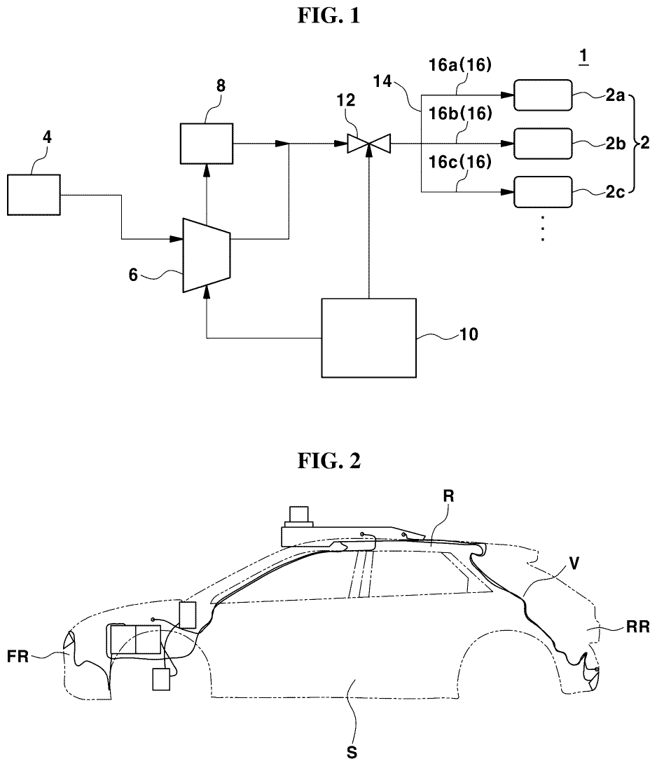

FIG. 1 illustrates a sensor cleaning system 1 provided in a vehicle according to an embodiment of the present disclosure. The sensor cleaning system 1 is configured to clean environmental sensors 2 (2a, 2b, 2c) using a compressed fluid, such as compressed air. The environmental sensor 2 may include sensing devices, such as LiDAR sensors, radar sensors, and cameras. This environmental sensor 2 may be arranged at various locations on a vehicle V, such as a front portion FR, a rear portion RR, a side portion, a roof R, and sides S, as illustrated in FIG. 2. Although three environmental sensors are disclosed in the drawings and specification, the number thereof is not limited to three and may be subject to change.

In an embodiment, an air cleaning system in which cleaning is performed using compressed air is described below. The air filtered through a filter 4, provided in the vehicle V, is introduced into a compressor 6. The air compressed by the compressor 6 is sprayed onto the surface of the environmental sensor 2, thereby removing foreign substances from the environmental sensor 2. In addition, the sensor cleaning system 1 may include a compression tank 8. The air, compressed by the compressor 6 or by an external device, may be filled into the compression tank 8, and the air filled in the compression tank 8 may be used to clean the environmental sensor 2.

The sensor cleaning system 1 includes a controller 10 configured to operate a valve 12, such as a solenoid valve, at preset intervals or under predefined conditions, such as when contamination of the environmental sensor 2 is detected. As a result, compressed air is sprayed from the compressor 6 or compression tank 8 to each environmental sensor 2, thereby enabling the cleaning of the environmental sensor 2. The valve 12 is equipped with or integrally formed with a distributor 14, allowing the compressed air to be distributed through nozzles 16 (16a, 16b, 16c) provided for each of the plurality of environmental sensors 2.

In vehicles, compressors, particularly air compressors, have mainly been used for air suspension. Compressors for air suspension typically require lower flow rates and operate less frequently compared to those used in sensor cleaning systems. In contrast, recent vehicle sensor cleaning systems require compressors capable of providing higher pressure and a larger volume of air.

In other words, in the case of vehicle compressors, they need to be capable of generating high-pressure compressed air in a compact size. Such compressors may include piston-type reciprocating compressors.

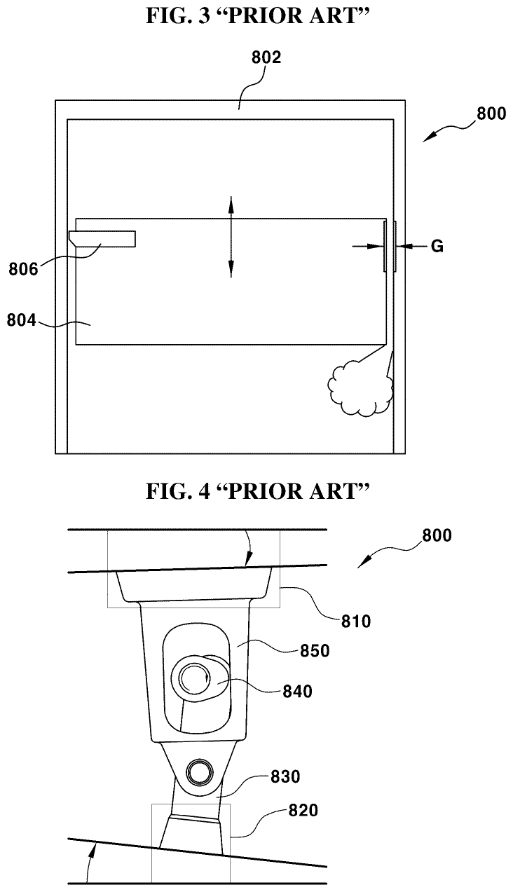

As illustrated in FIG. 3, a piston-type compressor 800 is configured to compress air as a piston head 804 performs a linear reciprocating motion inside a cylinder 802. To enable this operation, a certain gap G may exist between the cylinder 802 and the piston head 804. The air taken into the cylinder 802 may escape through the gap G during the operation of the compressor 800, which may reduce compression efficiency.

To prevent a decrease in compression efficiency, the compressor 800 may include a piston ring 806. However, despite the presence of the piston ring 806, a gap resulting from ovality caused by the angular misalignment of the piston head 804 during the operation of the compressor 800 (as indicated by the arrow in FIG. 4) tends to be difficult to eliminate, even with the piston ring 806, unlike the gap G.

For example, as illustrated in FIG. 4, the compressor 800 is configured to primarily compress a large volume of air at low pressure in a low-pressure cylinder 810. Then, the primarily compressed air moves into an opposite high-pressure cylinder 820, where secondary compression occurs to generate high-pressure air. For instance, the low pressure and high pressure may be referred to as a first pressure and a second pressure, respectively. The second pressure may be higher than the first pressure.

A high-pressure piston 830 connected to the high-pressure cylinder 820 is directly connected to an eccentric rotation shaft 840, and the high-pressure piston 830 is coupled to a low-pressure piston 850. Under this structure, a complete linear reciprocating motion of the high-pressure piston 830 and low-pressure piston 850 is not possible, so the occurrence of a gap caused by ovality is inevitable.

Therefore, the present disclosure provides a compressor that may realize a complete linear reciprocating motion and prevent the formation of a gap. Accordingly, the compressor according to the present disclosure may increase the compression efficiency of piston-type compressors.

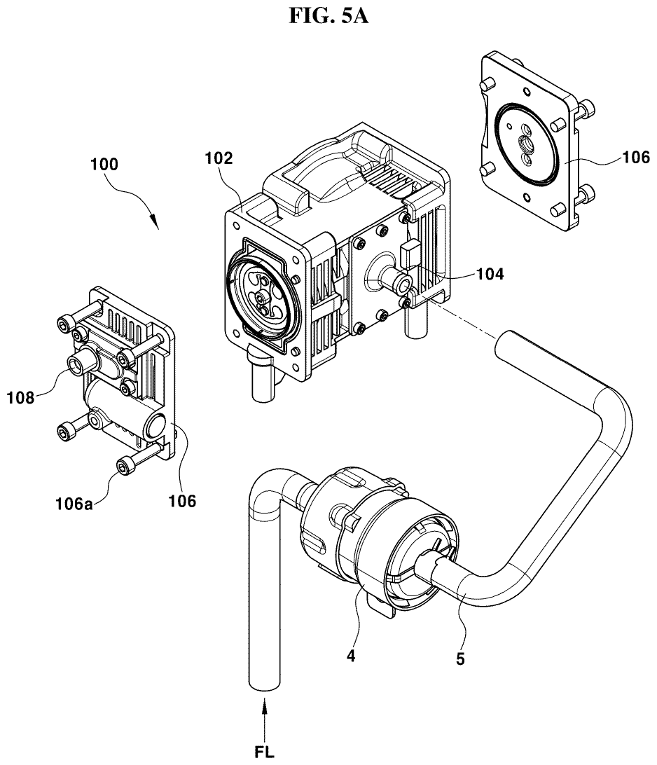

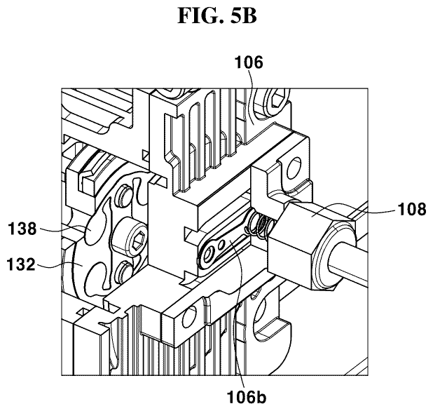

As illustrated in FIG. 5A, a compressor 100 is configured to generate compressed fluid. To accomplish this, the compressor 100 is configured to take in a fluid FL and compress it. In an embodiment, the fluid FL may be air.

The compressor 100 may include a housing 102 provided with an inlet 104 for intake of the fluid FL. The inlet 104 may be connected to the filter 4 through a pipe 5.

In an embodiment, the compressor 100 may include a pair of cover plates 106. The pair of cover plates 106 may be coupled to the housing 102. In particular, the cover plate 106 may be airtightly coupled to the housing 102. In an embodiment, the cover plates 106 may be coupled to the housing 102 using fastening members such as bolts 106a. However, coupling the cover plates 106 to the housing 102 may be performed using other known methods, and the housing 102 and the cover plates 106 may also be integrally formed.

The compressor 100 is configured to discharge the compressed fluid. The compressor 100 includes an outlet 108 to discharge the compressed fluid. In an embodiment, the outlet 108 may be formed in each of the cover plates 106.

As illustrated in FIG. 5B, the cover plate 106 may be provided with a check valve 106 b. The check valve 106b is configured to open and close based on the fluid FL. During the compression operation of the compressor 100, the check valve 106b may open, and during the intake operation of the compressor 100, the check valve 106b may close. Therefore, the fluid FL introduced into the compressor 100 through the inlet 104 may be selectively discharged through the outlet 108 by the operation of the check valve 106b on the cover plate 106.

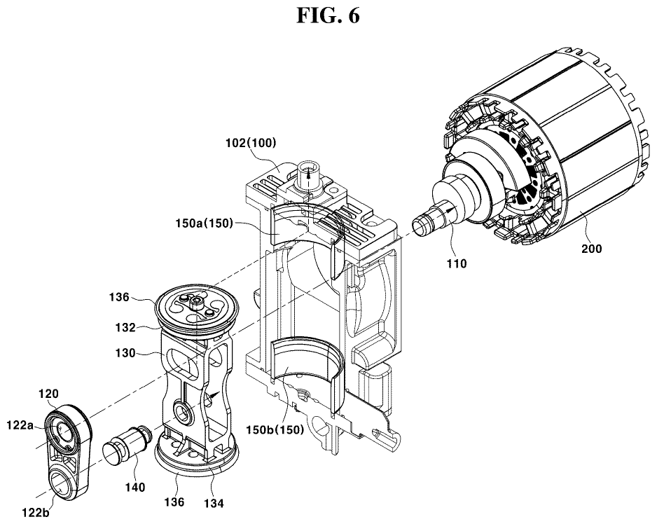

As illustrated in FIG. 6, the compressor 100 may be driven by a power device 200. In an embodiment, the power device 200 may include a motor. The compressor 100 may be driven by the rotation of an eccentric shaft 110, which is configured to rotate upon receiving a rotational force from the power device 200. In an embodiment, the eccentric shaft 110 may be eccentrically coupled to the rotation shaft of the power device 200. According to an embodiment of the present disclosure, a rotational motion of the eccentric shaft 110 may be converted into a complete or pure linear reciprocating motion of a piston.

In an embodiment of the present disclosure, the compressor 100 includes a piston. The piston may include a piston rod 120 and a piston body 130. The piston rod 120 may be connected to the eccentric shaft 110, and the piston rod 120 may be connected to the piston body 130.

In an embodiment, the piston rod 120 may include at least two connection parts (i.e., 122a, 122b). For example, the connection parts (122a and 122b) may be through-holes formed in the piston rod 120. Among the at least two connections part, a first connection part 122a may receive the eccentric shaft 110, allowing the piston rod 120 to be coupled to the eccentric shaft 110. The piston rod 120 and the piston body 130 may be connected by a second connection part 122b among the at least two connection parts. In an embodiment, the piston rod 120 and the piston body 130 may be connected by a pin 140 arranged at the second connection part 122b. Accordingly, the rotational motion of the piston rod 120 may cause the linear motion of the piston body 130. The piston rod 120 and the piston body 130 may be coupled in a substantially parallel manner by the pin 140. In other words, the pin 140 may be arranged substantially perpendicular to the piston rod 120 and the piston body 130.

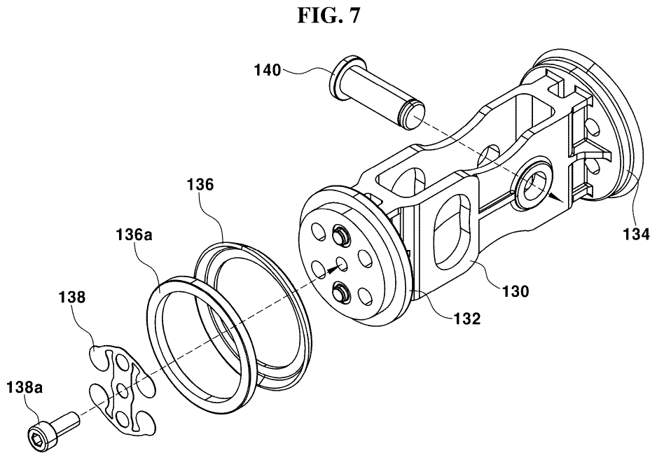

As illustrated in FIG. 7, the piston body 130 may include at least two piston heads (i.e., 132 and 134). The at least two piston heads (132 and 134) include a first piston head 132 and a second piston head 134. The piston heads 132 and 134 may be provided at the ends of the piston body 130, respectively. In an embodiment, the first piston head 132 and the second piston head 134 may have a symmetrical configuration.

In an embodiment, a piston ring 136 may be arranged on each of the piston heads 132 and 134. Each piston ring 136 may be secured to the respective piston heads 132 and 134 by a fixing member 136a. As a non-limiting example, the piston ring 136 may be made of Teflon. In an embodiment, a check valve 138 may be arranged on each of the piston heads 132 and 134. The check valve 138 may allow the fluid to be drawn in through the inlet 104. Each check valve 138 may be secured to the respective piston heads 132 and 134 by a fastening bolt 106a.

The housing 102 may be provided with at least two cylinders 150. The at least two cylinders 150 may include a first cylinder 150a and a second cylinder 150b. The piston heads 132 and 134 are configured to move in the cylinders 150, respectively.

Chambers 160 may be formed by the cylinders 150 and the piston heads 132 and 134. A first chamber 160a is formed by the first cylinder 150a and the first piston head 132, and a second chamber 160b is formed by the second cylinder 150b and the second piston head 134. Each of the first and second chambers 160a, 160b may expand or contract in response to movement of the piston. In an embodiment, the first chamber 160a and the second chamber 160b are configured to expand or contract alternately.

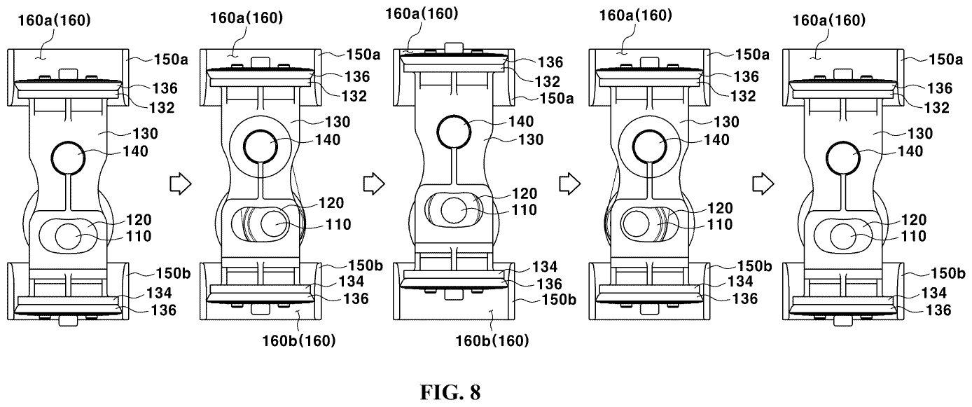

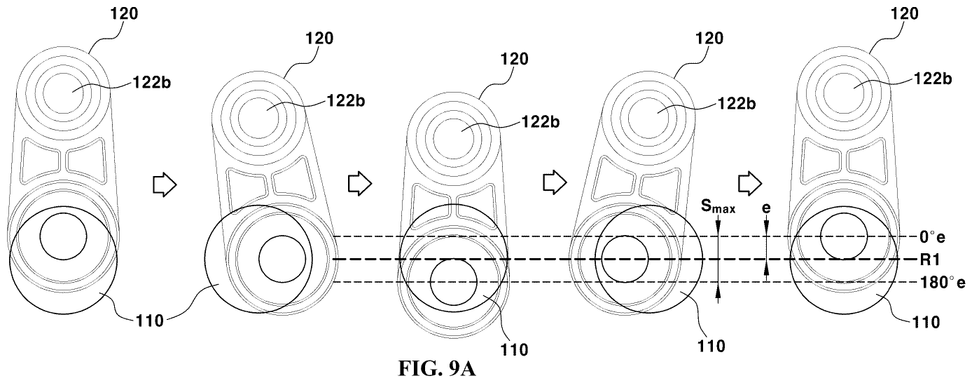

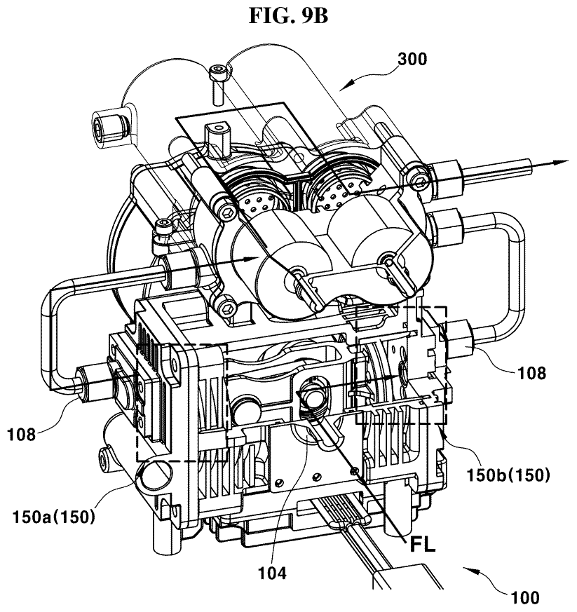

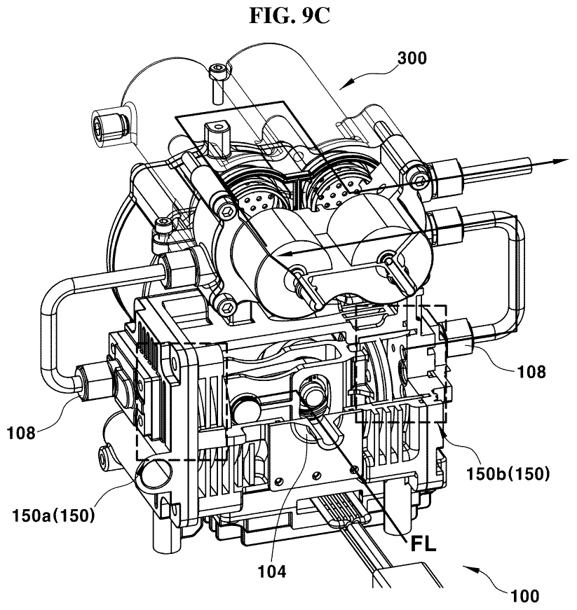

The operation of the compressor 100 is described with reference to FIGS. 8-9A, which illustrate movement of the piston during one full rotation of the eccentric shaft 110. FIGS. 8-9A show states of the eccentric shaft 110 at angles 0°, 90°, 180°, 270°, and 360° from left to right, respectively. In the drawings, the amount of eccentricity is denoted as “e”, the maximum stroke as “Smax”, and “R1” refers to the rotation shaft of the power device 200, which is the motor.

The eccentric shaft 110 begins to rotate by the power device 200. As a result, the first connection part 122a of the piston rod 120, connected to the eccentric shaft 110, is configured to move in a circular motion. The second connection part of the piston rod 120 is connected to the piston body 130 by the pin 140. The piston heads 132 and 134 of the piston body 130 are each constrained with one degree of freedom to perform a linear motion within their respective cylinders 150, and are configured to move with a stroke equal to twice eccentricity “e” of the eccentric shaft 110. The role of the one degree of freedom constraint is provided by the coupling between the piston body 130 and the cylinder 150, and the coupling between the piston body 130 and the piston rod 120 by the pin 140.

The first piston head 132 and the second piston head 134 are arranged at both ends of the piston body 130 and connected by the piston body 130. As a result, the first piston head 132 and the second piston head 134 are configured to always operate with a 180° phase difference.

In other words, when one of the two cylinders 150 is in the compression process, the other cylinder 150 may be in the intake process. For example, FIG. 9B illustrates a state where the first cylinder 150a is in the compression or discharge process, and the second cylinder 150b is in the intake process. As illustrated, the fluid FL is introduced into the housing 102 through the inlet 104 by the driving of the power device 200. The fluid FL in the housing 102 is introduced into the second chamber 160b of the second cylinder 150b. In this case, the check valve 106b is in a closed state. At the same time, the fluid FL in the first chamber 160a of the first cylinder 150a may be discharged through the outlet 108 on the first cylinder side, thereby generating compressed fluid. The check valve 106b on the first cylinder 150a side may open. FIG. 9C illustrates a state where the first cylinder 150a is in the intake process, and the second cylinder 150b is in the compression process. When the power device 200 is driven, the fluid may be introduced into the housing 102 through the inlet 104. The introduced fluid is introduced into the first chamber 160a of the first cylinder 150a, and the check valve 106b on the second cylinder side is in a closed state. At the same time, the fluid FL in the second chamber 160b of the second cylinder 150b may be discharged through the outlet 108 on the second cylinder 150b side, thereby generating compressed fluid. In this case, the check valve 106b on the second cylinder 150b side may open.

As described, according to the present disclosure, by integrating the two piston heads 132 and 134 into a single rigid piston body 130, both piston heads 132 and 134 in the cylinders 150 may be driven simultaneously by a single power source.

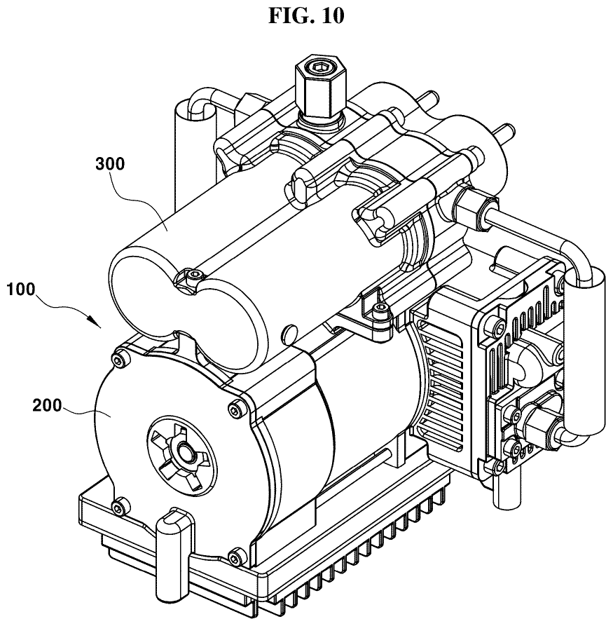

Referring to FIG. 10, according to an embodiment of the present disclosure, the compressor 100 may include a dryer 300. The dryer 300 is configured to remove moisture present in the compressed air. For example, the dryer 300 may include a regenerable adsorbent, and the compressed air passing through the adsorbent may have moisture removed. The adsorbent, which may be silica gel for example, refers to a substance that contains pores within its crystal structure and has the ability to absorb moisture.

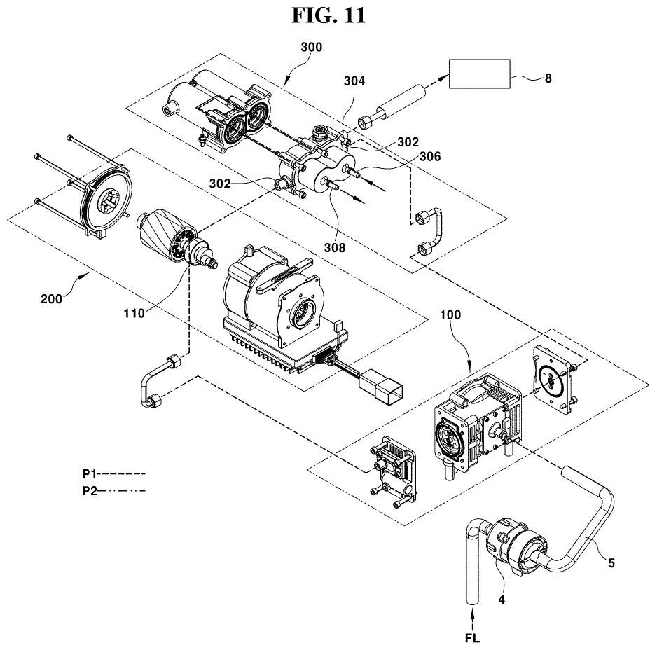

FIG. 11 illustrates a compression path P1, which is the airflow path in the compression mode of the compressor 100 and a regeneration path P2, which is the airflow path in the regeneration mode of the dryer 300 according to the embodiment of the present disclosure. For the continuous use of the dryer 300, periodic regeneration for dehydration needs to be performed, and the regeneration mode may refer to this dehydration process.

The compressed air generated by the compressor 100 is configured to pass through the dryer 300 before being stored in the compression tank 8. In the compression path P1, the path of the compressed air is directed from the compressor 100 to the dryer 300, and the dried compressed air may be directed to the compression tank 8. The compressed air from the compressor 100 may be introduced through a compressed air inlet 302 of the dryer 300 and pass through the dryer 300 to remove moisture. The compressed air, with moisture removed, may be discharged through a compressed air outlet 304 of the dryer 300 and directed to the compression tank 8.

In contrast, in the regeneration mode, the dry compressed air in the compression tank 8 is directed to the dryer 300 along the regeneration path P2. The compressed air from the compression tank 8 may be introduced into the dryer 300 through a dry air inlet 306 of the dryer 300. The compressed air introduced into the dryer 300 is configured to pass through the dryer 300 to remove moisture in the dryer 300 and be discharged through an outlet 308.

In an embodiment of the present disclosure, the compressor 100 may be used in the sensor cleaning system 1 of the vehicle V. However, it should be apparent to those having ordinary skill in the art that the compressor 100 may be used not only in the sensor cleaning system 1 but also in other systems.

The compressor according to the present disclosure may prevent the occurrence of a gap caused by ovality between the cylinder and the piston head, which decreases compression efficiency that mainly occurs in piston-type compressors. Accordingly, the compressor according to the present disclosure may greatly increase the compression efficiency of compressors, particularly small compressors.

A compressor with high compression efficiency operates at a lower frequency, which may reduce power consumption. Therefore, the compressor according to the present disclosure may provide the benefit of improving the vehicle's efficiency (fuel economy or electric efficiency).

The present disclosure described above is not limited to the above-described embodiments and the accompanying drawings, and it should be apparent to those having ordinary skill in the art that various substitutions, modifications, and changes are possible within the scope that does not depart from the technical spirit of the present disclosure.

What is claimed is:

1. A compressor comprising:
a piston rod eccentrically coupled to a rotation shaft of a power device;
a piston body connected to the piston rod and configured to linearly move, wherein the piston body includes a first piston head and a second piston head;
a first cylinder configured to intake or discharge fluid based on movement of the first piston head within the first cylinder; and
a second cylinder configured to intake or discharge the fluid based on movement of the second piston head within the second cylinder.

2. The compressor of claim 1, further comprising
an eccentric shaft configured to eccentrically couple the piston rod to the rotation shaft.

3. The compressor of claim 1, further comprising
a pin connecting the piston rod to the piston body.

4. The compressor of claim 1, wherein the piston rod comprises:
a first connection part configured to be connected to the rotation shaft; and
a second connection part, wherein a pin is inserted into the second connection part to connect the piston rod to the piston body.

5. The compressor of claim 1, wherein the first piston head and the second piston head are formed at both ends of the piston body, respectively.

6. The compressor of claim 1, further comprising
a housing in which the first cylinder and the second cylinder are arranged,
wherein the housing comprises:
an inlet configured to allow the fluid to be introduced; and
an outlet configured to discharge the fluid from the first cylinder and the second cylinder.

7. The compressor of claim 6, wherein the outlet is formed on each of the first cylinder and the second cylinder.

8. The compressor of claim 6, further comprising
a check valve arranged on each of the first piston head and the second piston head,
wherein the fluid introduced through the inlet is directed into the first cylinder and the second cylinder, respectively, by opening the corresponding check valves.

9. The compressor of claim 1, further comprising
a piston ring mounted on each of the first piston head and the second piston head.

10. The compressor of claim 1, further comprising:
a first chamber defined by the first cylinder and the first piston head, and configured to expand and contract; and
a second chamber defined by the second cylinder and the second piston head, and configured to expand and contract.

11. The compressor of claim 10, wherein the second chamber expands as the first chamber contracts, and the second chamber contracts as the first chamber expands.

12. The compressor of claim 1, further comprising
a dryer configured to be in fluid communication with the first cylinder and the second cylinder.

13. A sensor cleaning system, comprising:
a compressor; and
a compression tank configured to store compressed fluid generated by the compressor, wherein the compressor comprises:
a piston rod eccentrically coupled to a rotation shaft of a power device;
a piston body connected to the piston rod and configured to linearly move, wherein the piston body includes a first piston head and a second piston head;
a first cylinder configured to intake or discharge fluid based on movement of the first piston head within the first cylinder; and
a second cylinder configured to intake or discharge the fluid based on movement of the second piston head within the second cylinder.

14. The sensor cleaning system of claim 13, further comprising
a dryer configured to be in fluid communication with the first cylinder and the second cylinder, wherein the compressed fluid generated by the compressor in a compression mode is configured to be stored in the compression tank through the dryer.

15. The sensor cleaning system of claim 14, wherein, in a regeneration mode of the compressor, the compressed fluid stored in the compression tank is discharged through the dryer.

16. The sensor cleaning system of claim 13, further comprising
a nozzle configured to spray the compressed fluid.

17. The sensor cleaning system of claim 16, wherein the nozzle is configured to spray the compressed fluid onto an environmental sensor arranged in a vehicle.

18. The sensor cleaning system of claim 17, wherein the environmental sensor includes one or more of a LiDAR sensor, a radar sensor, or a camera.

19. The sensor cleaning system of claim 13, wherein the compressed fluid is compressed air.

20. The sensor cleaning system of claim 13, wherein the first piston head and the second piston head are formed at both ends of the piston body, respectively.
